(19) United States
(12) Patent Application Publication
(10) Pub. No.: US 2014/0122629 A1
(43) Pub. Date: May 1, 2014

(54) Information Acquisition Method and Device

(71) Applicant: Tencent Technology (Shenzhen) Company Ltd., Shenzhen (CN)

(72) Inventor: Yu Ku, Shenzhen (CN)

(73) Assignee: Tencent Technology (Shenzhen) Company Ltd., Shenzhen (CN)

(21) Appl. No.: 14/148,224

(22) Filed: Jan. 6, 2014

Related U.S. Application Data
(63) Continuation of application No. PCT/CN2012/076510, filed on Jun. 6, 2012.

(30) Foreign Application Priority Data
Jul. 5, 2011 (CN) 201110187444.7

(51) Int. Cl. H04L 12/58

(52) U.S. Cl. CPC H04L 51/16
USPC 709/206

(57) ABSTRACT

Disclosed are an information acquisition method and an information acquisition device. A search bar is added on a microblog homepage loaded on a client. Upon receiving a tag keyword input by a user through the search bar, the client sends the tag keyword to a server to match client users who have the same tag as the client user, receives related information of the matched client users that have the same tag as the client user, and then presents the related information to the client user. Therefore, the search speed of the client is increased, and the search accuracy is guaranteed, thereby further optimizing the microblog functions loaded on the client.

### FIELD OF THE DISCLOSURE

The present disclosure relates to internet technologies, and more particularly to an information acquisition method and device.

### BACKGROUND

With the development of the internet technology, a variety of functions based on the internet are more and more. Microblog is one of the variety of functions based on the internet. Microblog is an abbreviation of micro-blogging, and is an information sharing, dissemination and acquisition internet platform based on user-relationships. Microblog allows users to form individual communities through WEB, Wireless Application Protocol (WAP) and various clients and update information with about 140 words and realize the sharing in time. In a microblog client software, a user can mark himself/herself with a personalized tag according to his/her interests, hobbies and characteristics, etc., and can find other users who have a same tag as the user, so as to make further communication with the other users who have the same tag as the user.

In the existing microblog client software, a client user needs to view detailed information of other users to find other client users who have the same tag as the client user, so as to further view microblog messages of the other client users.

In the related art, one method for searching for other client users who have the same tag as the client user includes: viewing detailed information of other client users so as to view tags of other client users in the detailed information of the other users, and judging whether each of the tags is the same as that of the client user. After viewing detailed information of many other client users, the client user may find just one other client user who has the same tag as the client user. This method has a lower efficiency and the search speed is too slow. The client user may find just one other client user who has the same tag as the client user after viewing detailed information of ten or more other client users.

### SUMMARY

One embodiment of the present disclosure provides an information acquisition method, which can improve the search speed when searching for other client users who have the same tag as a client user.

One embodiment of the present disclosure also provides an information acquisition device, which can improve the search speed when searching for other client users who have the same tag as a client user.

In order to achieve the purpose of the present disclosure, the technical solution of the present disclosure can be as follows.

An information acquisition method includes:
acquiring a tag keyword input by a client user;
acquiring related information of other client users who have a same tag as the client user according to the tag keyword; the related information at least including tag information of the other client users who have the same tag as the client user;
displaying the related information of the other client users who have the same tag as the client user.

An information acquisition device includes:
a search logic management control module configured to acquire a tag keyword input by a client user;
a data pull and storage module configured to, according to the tag keyword, acquire related information of other client users who have a same tag as the client user, the related information at least including tag information of the other client users who have the same tag as the client user;
a search result page display module configured to display the related information of the other client users who have the same tag as the client user.

It can be seen from the above technical solution, in the information acquisition method and device provided in embodiments of the present disclosure, a search bar is added on a microblog homepage loaded on a client; upon receiving a tag keyword input by a user through the search bar, the client sends the tag keyword to a server to match client users who have the same tag as the client user, receives related information of the matched client users who have the same tag as the client user, and then presents the related information to the client user. Therefore, the search speed of the client is increased, and the search accuracy is guaranteed, thereby further optimizing the microblog functions loaded on the client.

### BRIEF DESCRIPTION OF DRAWINGS

In order to more clearly illustrate technical solutions of embodiments of the present disclosure, the figures which are needed to be used in the description of the embodiments will be briefly described in the following. Obviously, the figures in the following description are only some embodiments of the present disclosure, and it is easily for those skilled in the art to obtain other figures based on the following figures without creative work.

FIG. 1 is a flow chart of an information acquisition method provided in embodiment one of the present disclosure;

FIG. 2 is a flow chart of an information acquisition method provided in embodiment two of the present disclosure;

FIG. 3 is a schematic diagram of displaying search results provided in the embodiment two of the present disclosure;

FIG. 4 is a schematic diagram of an information acquisition device provided in an embodiment three of the present disclosure;

FIG. 5 is a schematic diagram of another information acquisition device provided in an embodiment three of the present disclosure.

### DETAILED DESCRIPTION

In order to make the objectives, technical solutions, and advantages of the present disclosure clear, the technical solutions of the embodiments of the present disclosure are hereinafter further explained in details with reference to drawings. Obviously, the described embodiments are only some embodiments of the present disclosure and are not all embodiments. Based on the embodiments of the present disclosure, all other embodiments made by those skilled in the art without creative work should fall within the scope of the present disclosure.

It can be seen from the background art, one reason why the search speed is slower when searching for other clients users who have the same tag as the client user is: the client acquires detailed information of other client users, and then finds other clients users who have the same tag as the client user by viewing the detailed information of other client users one by one. That is, the search process is manually completed in the client locally, this results in that the searching can be artificially influenced and is not accurate, and the search speed is slower.

Thus, in one embodiment of the present disclosure, when searching for other client users who have the same tag as the client user, an internet server searches for other client users who have the same tag as the client user according to a tag keyword input by the client user and acquired from the client, and returns the searched other client users who have the same tag as the client user to the client, and the client displays the searched other client users who have the same tag as the client user to the client user. In this way, the search process is completed in the server, since search function of the server is better than that of the client and the server does not need to send a large amount of detailed information of other client users to the client, thus, the search speed is increased. Since there is no human factor in the search process, thus the searching is accurate, thereby further optimizing the microblog functions loaded on the client.

Hereinafter, embodiments of the present disclosure will be described in detail.

### EMBODIMENT ONE

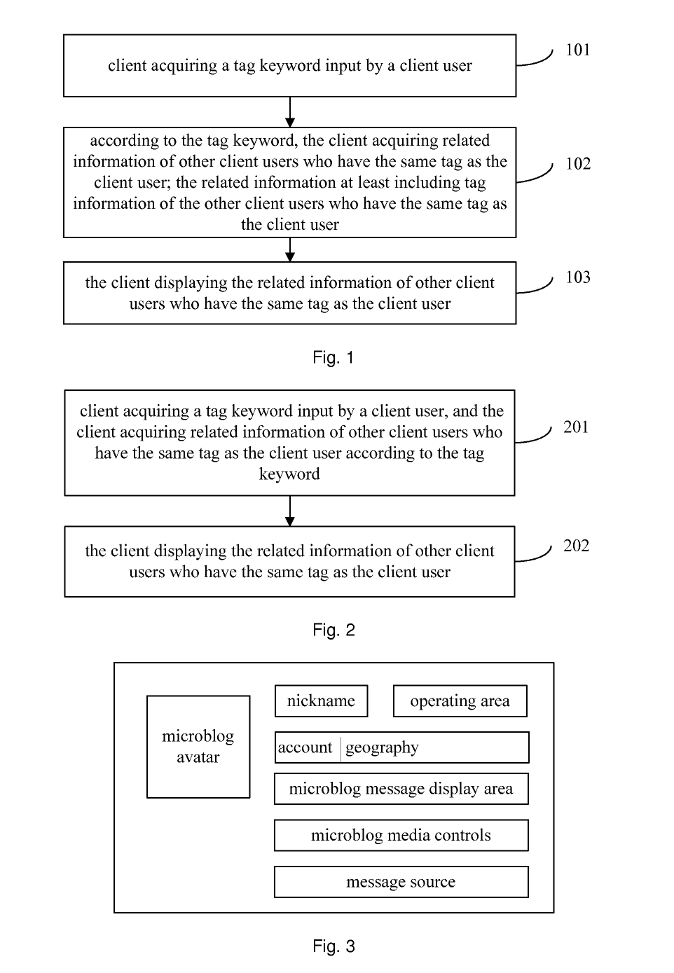

FIG. 1 is a flow chart of an information acquisition method provided in embodiment one of the present disclosure; referring to FIG. 1, the method includes following steps.

Step 101: a client acquiring a tag keyword input by a client user;

Step 102: according to the tag keyword, the client acquiring related information of other client users who have a same tag as the client user; the related information at least including tag information of the other client users who have the same tag as the client user;
In this step, after the client receives the tag keyword input by the client user through a search bar of a microblog homepage loaded on the client, the client sends the tag keyword to a server to match client users who have the same tag as the client user, and receives related information of the matched client users who have the same tag as the client user from the server.

Step 103: the client displaying the related information of other client users who have the same tag as the client user.

In this embodiment, according to the tag keyword, acquiring related information of users who have the same tag as the client user includes:
sending the tag keyword to the server to make the server search for related information of other client users who have the same tag as the client user according to the tag keyword;
receiving and storing related information of other client users who have the same tag as the client user returned by the server.

In this embodiment, the related information can further include one of avatar information, nickname information, account information, and microblog messages, or any combination thereof.

In this embodiment, the method can further include:
when the client user opens any one webpage on the client, acquiring key information of a microblog message in the webpage;
judging whether the microblog message is stored in a memory, according to the key information of the microblog message in the webpage;
if yes, increasing a reference number of the microblog message.

Preferably, the method further includes:
when microblog messages stored in the client reaches to a preset number, judging whether there is one microblog message whose reference number is smaller than a predetermined number of times in the microblog messages;
if there is one microblog message whose reference number is smaller than the predetermined number of times in the microblog messages, deleting the microblog message whose reference number is smaller than the predetermined number of times.

Preferably, the displaying the related information of other client users who have the same tag as the client user includes:
receiving the client user's request for displaying the related information of other client users who have the same tag as the client user;
judging whether there is a corresponding control for the client to display the related information of other client users who have the same tag as the client user;
if there is a corresponding control for the client to display the related information of other client users who have the same tag as the client user, adding the related information of other client users who have the same tag as the client user to the corresponding control for displaying.

### EMBODIMENT TWO

FIG. 2 is a flow chart of an information acquisition method provided in embodiment two of the present disclosure; referring to FIG. 2, the method includes following steps.

Step 201: a client acquiring a tag keyword input by a client user, and the client acquiring related information of other client users who have the same tag as the client user according to the tag keyword.

A new microblog software is provided in this embodiment. The microblog software adds a search bar on a microblog homepage. After the microblog software is installed on the client, the client user can find needed information by inputting a keyword in the search bar. For example, if the client user likes playing football, the client user's personal tag can be set as “football”; if the client user wants to search for other client users who have the same tag as the client user, the client user can input the tag keyword “football” into the search bar.

In this embodiment, preferably, one client installed with the microblog software can include a search result page display module, a search logic management control module and a data pull and storage module.

The search result page display module is mainly configured to display a page which encapsulates results of searching the tag and interact with users.

The search logic management control module is mainly responsible for corresponding logic processing of an action of a corresponding presentation layer, data pull timing, callback processing, state storage, and so on.

The data pull and storage module mainly includes acquiring (including network pulling) and organizing data needed to be displayed.

In this embodiment, preferably, acquiring related information of other client users who have the same tag as the client user according to the tag keyword includes:
1) the client sending the tag keyword to a server to make the server search for related information of other client users who have the same tag as the client user according to the tag keyword;
2) receiving and storing related information of other client users who have the same tag as the client user returned by the server.

In this embodiment, specifically, the data pull and storage module can trigger a corresponding information pulling process with the server, store related information after the completion of information pulling, and provide a corresponding interface for the search logic management control module to search in the data pull and storage module. Further, in this embodiment, in order to reduce the load brought to the server as much as possible, a single pull strategy will not be adopted if information can be pulled in batch. For example, after the client user inputs “football” in the step 201, the client sends “football” to the server; according to the tag keyword, the server searches for related information of other client users who have the same tag as the client user. The related information includes tag keywords and microblog messages of other client users who have the same tag as the client user. When the server finds an other client user who has the same tag as the client user, the server pulls microblog messages of the other client user and sends the microblog messages of the other client user to the client which searches for “football”. Preferably, the server can send the other client user's recently published microblog message or microblog message with more forwarding times to the client.

In this embodiment, the client stores the related information of other client users who have the same tag as the client user returned by the server; with the increase of information, high consumption of the memory is inevitable, thus, it is needed to develop a certain strategy to reduce the consumption of the memory caused by the program as much as possible, preferably, the strategy can include:
when microblog messages stored in the client reaches to a preset number, judging whether there is one microblog message whose reference number is smaller than a predetermined number of times in the microblog messages;
if there is one microblog message whose reference number is smaller than the predetermined number of times in the microblog messages, deleting the microblog message whose reference number is smaller than the predetermined number of times.

Preferably, the above strategy can be achieved by setting a message pool within the program. The message pool can be configured to store all message content and adopt a certain elimination algorithm to release no longer needed messages after a number of pieces of messages reaches a certain limit. On the other hand, the message pool can also be configured to maintain a reference count for one piece of message. Preferably, when the client user opens any one webpage on the client, the client acquires related information of a microblog message in the webpage, and judges whether the microblog message is stored in the memory according to the related information of the microblog message in the webpage. If the microblog message is stored in the memory, the client increases a reference number of the microblog message. For instance, if one page displays this message, then the reference number of this message is plus one. For example, the client stores a microblog message of an other client user who has a tag of “football”; when the client user opens a webpage, the client acquires a microblog message in this webpage, and judges whether the microblog message in this webpage is stored in the memory according to key information of the microblog message; if the microblog message in this webpage is the microblog message of the other client user who has a tag of “football” stored in the client, the reference number of the microblog message is plus one. On the contrary, during destruction of the webpage, one is subtracted from the reference number of the microblog message. In this embodiment, the predetermined number of times can be one or two, and this is not specifically limited in this embodiment. For example, when a number of messages in the message pool reaches a certain limit and one message with a reference account of one is found, it indicates that no control displays this message, then memory data of this message can be released, that is to delete the message from the message pool.

Step 202: the client displaying the related information of other client users who have the same tag as the client user.

Referring to FIG. 3, in this embodiment, preferably, after the tag keyword is input, a schematic diagram of the related information of other client users who have the same tag as the client user displayed according to the search results is shown. The displayed result includes microblog avatar, nickname, operating area, microblog message display area, microblog media controls, message source, and so on.

In this embodiment, preferably, in specific implementations, a search result detached child class, UserltemCtrl, can be configured to process interface presentation logic of each child control in a list control; for all child controls, there is a list control management class, UserltemMgr, which can be configured to manage life cycles of all child controls in a list, etc.; further, there is also a delegate class interface for callbacking a list parent control, IpageltemContainer, which can be configured to obtain a pointer to the parent control, since there is an asynchronous pull process for broadcast messages, Tag information and avatar, etc., thus, a timing is required to notify the parent control to perform corresponding interface refresh and arrangement, etc., after the completion of information pulling in the UserltemMgr.

In this embodiment, the search logic management control module can store an instance of the UserltemMgr therein, which can be configured to notify the UserltemMgr to update the UserltemCtrl after the completion of pulling of corresponding messages.

In this embodiment, in order to improve the user's experience, displaying of the searched results including detailed information should be as quickly as possible. However, during an interaction process between the client and the server, a transmission byte number of one packet is restricted by a minimum byte number of network transmission which can be about 800 bytes. Here, a number of contents of information needed to be displayed is relatively large, just pulling the microblog message body may exceed 800 bytes; if the contents are displayed at the same time after all data of the users have been pulled back, this will bring a worse experience to the user, particularly in a bad network environment. Therefore, the displayed information can be divided into categories each having a certain priority according to the importance in the pulling process. For example, the displayed information can be divided into basic information such as a user account, a nickname, etc., user avatar information, a user's personal tag information, one piece of broadcast information recently published by the user, the user's geographical identification information, and so on. Since the basic information such as the user account, the nickname, etc. has fewer number of bytes and a highest priority, thus, the basic information can get a quick response and thus can be displayed first; while the personal tag information and other information can be asynchronously displayed to the user through one refresh process for a control after receiving returned packages.

In this embodiment, preferably, the program can include a container pool therein. When there is a need to create one UserltemCtrl, first finding whether there is a resource to be used in the current UserltemMgr; if there is a resource to be used in the current UserltemMgr, filling the UserltemCtrl with appropriate information, without consumption for creating a control; if there is not a resource to be used in the current UserltemMgr, then performing a corresponding creating action. Therefore, when performing actions such as pages turning, UserltemCtrl of a previous page is not actually destroyed, is put in a pool of resources to be used and is used for next displaying. Specifically, the client receives the client user's request for displaying the related information of other client users who have the same tag as the client user, judges whether there is a corresponding control for the client to display the related information of other client users who have the same tag as the client user; if there is a corresponding control for the client to display the related information of other client users who have the same tag as the client user, adds the related information of other client users who have the same tag as the client user to the corresponding control for displaying. For example, the client wants to view another user's microblog message, then, after receiving a request, the client first judges whether there is a corresponding control for the client to display the another user's microblog message. If there is a corresponding control for the client to display the another user's microblog message, the client adds the microblog message which the client user requests to view, to the control so as to display the microblog message which the client user requests to view. If there is not a corresponding control, a new control can be created to display the microblog message.

In the method provided in embodiments of the present disclosure, the message pool and the container pool can be adopted in the client microblog system to reduce the consumption of the memory caused by the program, thereby further optimizing system memory.

### EMBODIMENT THREE

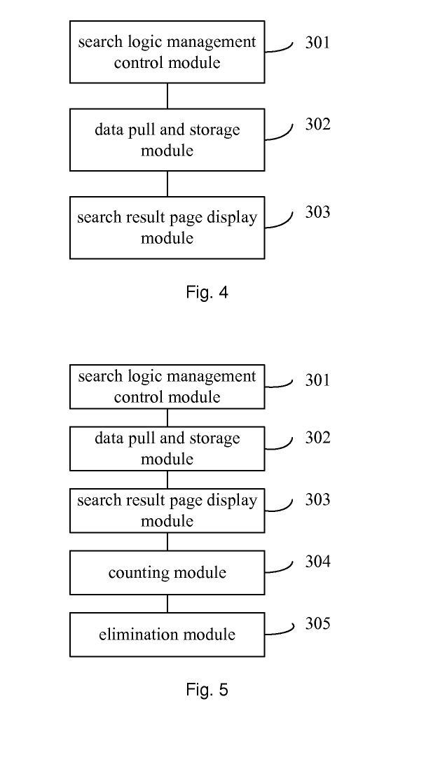

Referring to FIG. 4, FIG. 4 is a schematic diagram of an information acquisition device provided in embodiment three of the present disclosure. The information acquisition device includes a search logic management control module 301, a data pull and storage module 302 and a search result page display module 303.

The search logic management control module 301 is configured to acquire a tag keyword input by a client user.

The data pull and storage module 302 is configured to, according to the tag keyword, acquire related information of other client users who have the same tag as the client user. The related information at least includes tag information of the other client users who have the same tag as the client user.

The search result page display module 303 is configured to display the related information of other client users who have the same tag as the client user.

The data pull and storage module 302 includes:
a sending unit configured to send the tag keyword to a server to make the server search for related information of other client users who have the same tag as the client user according to the tag keyword;
a receiving unit configured to receive and store related information of other client users who have the same tag as the client user returned by the server.

Referring to FIG. 5, FIG. 5 is a schematic diagram of another information acquisition device provided in embodiment three of the present disclosure. The information acquisition device further includes:
a counting module 304 configured to, when the client user opens any one webpage, acquire key information of a microblog message in the webpage; according to the key information of the microblog message in the webpage, judge whether the microblog message is stored in a memory; if yes, increase a reference number of the microblog message.

Referring to FIG. 5, the information acquisition device in this embodiment further includes:
an elimination module 305 configured to, when microblog messages stored in the client reaches to a preset number, judge whether there is one microblog message whose reference number is smaller than a predetermined number of times in the microblog messages; if there is one microblog message whose reference number is smaller than the predetermined number of times in the microblog messages, delete the microblog message whose reference number is smaller than the predetermined number of times.

Preferably, the search result page display module 303 is specifically configured to, receive the client user's request for displaying the related information of other client users who have the same tag as the client user; judge whether there is a corresponding control for the client to display the related information of other client users who have the same tag as the client user; if there is a corresponding control for the client to display the related information of other client users who have the same tag as the client user, add the related information of other client users who have the same tag as the client user to the corresponding control for displaying.

Specifically, the device provided in this embodiment and the embodiment of the method belong to the same concept, and its specific implementation process can refer to the embodiment of the method and will not be repeated here.

One skilled in the art can understand that realization of the whole or parts of the steps in the above embodiments can be accomplished by hardware, or by a program instructing relevant hardware. The program may be stored in a computer readable storage medium, the above mentioned storage medium may be a read-only memory, magnetic or optical disk, etc.

The foregoing are only preferred embodiments of the present disclosure, and are not used to limit the present disclosure. Any modification, equivalent replacement, or improvement made without departing from the spirit and principle of the present disclosure should fall within the scope of the present disclosure.

What is claimed is:

1. An information acquisition method comprising:
acquiring a tag keyword input by a client user;
acquiring related information of other client users who have a same tag as the client user according to the tag keyword; the related information at least including tag information of the other client users who have the same tag as the client user;
displaying the related information of the other client users who have the same tag as the client user.

2. The method of claim 1, wherein the acquiring related information of other client users who have a same tag as the client user according to the tag keyword comprises:
sending the tag keyword to a server to make the server search for the related information of the other client users who have the same tag as the client user according to the tag keyword;
receiving and storing the related information of the other client users who have the same tag as the client user returned by the server.

3. The method of claim 1, wherein the related information further comprises one of avatar information, nickname information, account information and microblog information, or any combination thereof

4. The method of claim 3, further comprising:
when the client user opens any one webpage loaded on a client, acquiring key information of a microblog message in the webpage;
judging whether the microblog message in the webpage is stored in a memory of the client according to the key information of the microblog message in the webpage;
if yes, increasing a reference number of the microblog message stored in the memory.

5. The method of claim 3, further comprising:
when a number of microblog messages stored in the client reaches to a preset number, judging whether there is one microblog message whose reference number is smaller than a predetermined number of times in the microblog messages;
if yes, deleting the microblog message whose reference number is smaller than the predetermined number of times.

6. The method of claim 1, wherein the displaying the related information of the other client users who have the same tag as the client user comprises:
receiving the client user's request for displaying the related information of the other client users who have the same tag as the client user;
judging whether there is a corresponding control for the client to display the related information of the other client users who have the same tag as the client user;
if yes, adding the related information of the other client users who have the same tag as the client user to the corresponding control for displaying.

7. An information acquisition device comprising:
a search logic management control module configured to acquire a tag keyword input by a client user;
a data pull and storage module configured to, according to the tag keyword, acquire related information of other client users who have a same tag as the client user, the related information at least including tag information of the other client users who have the same tag as the client user;
a search result page display module configured to display the related information of the other client users who have the same tag as the client user.

8. The device of claim 7, wherein the data pull and storage module comprises:
a sending unit configured to send the tag keyword to a server to make the server search for the related information of the other client users who have the same tag as the client user according to the tag keyword;
a receiving unit configured to receive and store the related information of the other client users who have the same tag as the client user returned by the server.

9. The device of claim 7, wherein the device further comprises:
a counting module configured to, when the client user opens any one webpage loaded on a client, acquire key information of a microblog message in the webpage; according to the key information of the microblog message in the webpage, judge whether the microblog message in the webpage is stored in a memory of the client; if yes, increase a reference number of the microblog message stored in the memory.

10. The device of claim 7, wherein the device further comprises:
an elimination module configured to, when a number of microblog messages stored in the client reaches to a preset number, judge whether there is one microblog message whose reference number is smaller than a predetermined number of times in the microblog messages; if yes, delete the microblog message whose reference number is smaller than the predetermined number of times.

11. The device of claim 7, wherein the search result page display module is configured to, receive the client user's request for displaying the related information of the other client users who have the same tag as the client user; judge whether there is a corresponding control for the client to display the related information of the other client users who have the same tag as the client user; if yes, add the related information of the other client users who have the same tag as the client user to the corresponding control for displaying.
